(19) United States
(12) Patent Application Publication
(10) Pub. No.: US 2005/0278480 A1
(43) Pub. Date: Dec. 15, 2005

(54) Method of writing data into flash memory

(75) Inventors: Momoto Watanabe, Tokyo (JP); Hiroaki Sano, Saitama (JP); Takahiro Urushi, Tokyo (JP); Tadakazu Tanaka, Miyuzaki (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/055,996

(22) Filed: Feb. 14, 2005

(30) Foreign Application Priority Data
Jun. 15, 2004 (JP) 2004-176939

(51) Int. Cl. G06F 12/08

(52) U.S. Cl. 711/103; 711/207

(57) ABSTRACT

A system includes an address conversion table, block state table and address register. The address conversion table indicates relationship (correspondence) between logical blocks and physical blocks of a flash memory. The block state table indicates whether or not effective data has been written for each of the physical blocks. The address register preserves a logical address at which data was written the preceding time, and physical block numbers of a source and a destination. When “write start” is requested, new data is additionally written after former pages of the source block have been copied to the destination block. When “continued write” is requested, continued data is written into a page continuous to the page where the new data is written in the destination block. When “write end” is requested, pages of the source block are copied to unwritten pages of the destination block respectively.

### BACKGROUND OF THE INVENTION

1. Field of the Invention

The present invention relates to a method of writing data into a flash memory, and particularly relates to a writing method that can reduce a writing time and the number of times of re-writing.

2. Description of the Related Art

One of methods of writing data into a flash memory is disclosed in Japanese Patent Kokai (Laid-open Application) No. 2002-366430. Another example of data writing method for the flash memory is found in SSFDC Forum “Smart Media Software Algorithm Guideline (V1.00)”, p. 10-17 (May 19, 2000).

One of most common storage devices for digital cameras and the like is a flash memory which is one type of non-volatile memory. Stored contents are held in the non-volatile memory even after the power is shut off. The flash memories are classified into a NAND type and a NOR type. The NAND type flash memory is more frequently used because the NAND type flash memory has a higher writing speed and can easily provide large capacities. However, when writing and reading data, the NAND type flash memory can be only accessed in units of pages (for example, 512 bytes) due to its structure, and when erasing data, the data erasure can be done only in units of blocks. Each block is has a plurality of pages (for example, 32 pages).

Since the flash memory holds data by accumulating a charge on a floating gate with a high voltage applied thereto, the lifetime of the flash memory is dictated by the number of times an erasure and a write are repeated. If a particular block has been written a large number of times, the block can no longer be normally written, and in its turn, the overall flash memory will become unavailable.

Japanese Patent Kokai No. 2002-366430 discloses an apparatus including a plurality of independent flash memories. After data has been written into one flash memory, next data is immediately written into a different flash memory to substantially reduce a writing time and average the use frequency per block. This method is not suitable for a flash memory having a large capacity because a plurality of independent flash memories must be provided, and a complicated control method is involved.

SSFDCForum “SmartMediaSoftwareAlgorithmGuideline (V1.00)”, p. 10-17 (May 19, 2000) recommends a data writing method for a flash memory called “SmartMedia (trademark),” and one example is described. In this example, dataon pages 7-9 in a certain logical block are re-written by specifying logical addresses of logical pages. The detail of this example will be described below. A processor is connected to the flash memory.

First, when a write request is made from the processor to pages 7-9 of certain logical addresses, a logical block number is calculated (determined) from the specified logical addresses.

Second, a physical block number (herein called the “source block”) corresponding to this logical block number is identified with reference to a table which shows a relationship between logical block numbers and physical block numbers of the flash memory.

Third, a search is made for a physical block in which no effective data is written (herein called the “destination block”) with reference to a state table which indicates for each physical block whether or not effective data has been written, and data is erased from the determined destination block.

Fourth, old (or existing) data on pages 0-6 of the source block are sequentially read, and copied to pages 0-6, respectively, of the destination block.

Fifth, new data passed from the processor are sequentially written into pages 7-9 of the destination block.

Sixth, old data are sequentially read from pages 10-31 of the source block, and copied to pages 10-31, respectively, of the destination block.

In this way, the storage area of the flash memory can be managed in units of blocks and this facilitates the management of a memory having a large capacity because it is unnecessary to hold a correspondence table for the logical addresses, physical block numbers and physical page numbers in units of pages and a state table for each of the physical page numbers.

Since the data writing method described in SSFDC Forum “SmartMedia Software Algorithm Guideline (V1.00)”, p. 10-17 (May 19, 2000) is provided for purposes of randomly rewriting data in a flash memory on a page-by-page basis, pages not intended for rewriting are unconditionally copied from a source block to a destination block. Therefore, a data write involves writing all of 32 pages, thus failing to reduce a writing time.

### SUMMARY OF THE INVENTION

One object of a certain embodiment in the present invention is to provide a writing method which is capable of reducing a writing time, for example, when an image photographed by a digital camera is written into a flash memory.

According to one aspect of the present invention, there is provided an improved flash memory writing method for writing data into a flash memory. The flash memory is capable of writing data in units of physical pages. Each physical page has a certain storage area. The flash memory is also capable of erasing data in units of physical blocks. Each physical block has a predetermined number of continuous physical pages. A processor is connected to the flash memory. The processor specifies a logical address and issues a certain instruction, such as a write start instruction, a continued write instruction and a write end instruction. The instruction is supplied to the flash memory from the processor. A logical block number is obtained from the logical address. An address conversion table, block state table and address registers are connected to the processor and flash memory. The address conversion table indicates relationship between logical block numbers and physical blocks on the flash memory. A block state table indicates whether or not effective data has been written for each of the physical blocks. An address register preserves a logical address at which preceding data writing is made, and, physical block numbers of a source and a destination used in the preceding data writing.

When the processor instructs the write start, the method determines a logical block number from the specified logical address, and determines a page number within a block having the determined logical block number, from the specified logical address. The method then specifies a source physical block corresponding to the logical block number with reference to the address conversion table, and determines a destination physical block in which no effective data is written, with reference to the block state table. The method erases the contents stored in the determined destination physical block, and copies from the first physical page to a physical page preceding to the specified page number in the source physical block to the destination physical block. Subsequently, the method writes new data given by the processor into a physical page corresponding to the specified page number in the destination physical block.

When the processor instructs the continued write, the method writes another new data given by the processor into a page next to the physical page of the destination physical block into which data has been written by the write start instruction.

When the processor instructs the write end, the method copies corresponding pages in the source physical block to all remaining pages in the destination physical block.

Given an instruction for the write start, new data is additionally written in the specified page(s) after former pages of the source block have been copied to the destination block. Given an instruction for the continued write, continued data is written into subsequent page(s) into the destination block. In this way, data can be written faster than conventional writing methods when, for example, data are written into the flash memory at sequential addresses as done in a digital camera.

The above-mentioned and other objects, aspects, features and advantages of the present invention will become more fully apparent when reading the following description of the embodiment(s) with reference to the accompanying drawings. The drawings, however, are not intended to limit the scope of the present invention, but is merely provided for purposes of description.

### BRIEF DESCRIPTION OF THE DRAWINGS

FIG. 1 illustrates a system configuration according to one embodiment of the present invention;

FIG. 2 is a flow chart of a flash memory writing method, executed in the system shown in FIG. 1; and

FIG. 3A to FIG. 3C is a series of diagrams to explain the detail of the writing method of FIG. 2.

### DETAILED DESCRIPTION OF THE INVENTION

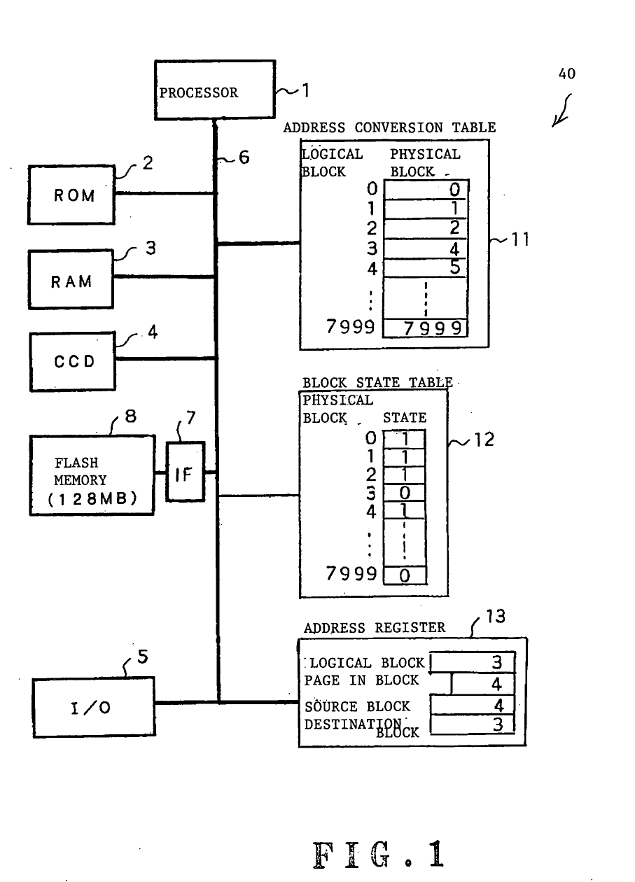

Referring to FIG. 1, a system 40 having a flash memory 8 according to one embodiment of the present invention will be described. This system 40 is a digital camera which employs a flash memory 8 as an external storage device for recording image data.

This system 40 includes a processor 1 for conducting a general control, a read-only memory (ROM) 2 which stores a control program, and a random access memory (RAM) 3 for temporarily storing captured image data and data in the middle of processing. The system 40 also includes a photographing device (CCD) 4 for capturing image data through opto-electric conversion, and an input/output device (I/O) 5 such as a shutter, a mode change-over switch, and a strobe. These elements of the system 40 are interconnected through a system bus 6.

The flash memory 8 can be connected to the system bus 6 through an interface (IF) 7. The flash memory 8 is an external storage device. The flash memory 8 is, for example, a NAND type having a total storage capacity of 128 MB which is comprised of 8000 physical blocks. Each physical block has 32 pages, and each page has a storage area of 512 bytes. The flash memory 8 has 8000×32 (=256000) pages. When accessing a data file on this flash memory 8, a storage location is specified by one or more logical addresses from “0” to “25599” in units of pages.

8000 physical blocks of the flash memory 8 are not fixedly assigned to the logical addresses but are dynamically related to the logical addresses upon updating of the data files.

This system 40 includes an address conversion table 11, a block state table 12, and an address register 13 for managing data files on the flash memory 8. Written into the address conversion table 11 are numbers of physical blocks dynamically related in correspondence to logical block numbers calculated from logical addresses (i.e., integers calculated by dividing logical addresses by 32 with their fractional portions being dropped).

The block state table 12 indicates for each physical block whether or not effective data has been written therein. In the block state table 12, “1” is set to the physical block concerned, when effective data has been written, and “0” is set when effective data has not been written. The address register 13 holds a logical address at which data was written the preceding time (i.e., a logical block number and a page number in this block used in the preceding data writing operation), and physical block numbers of a source and a destination used in the preceding data writing operation.

In a normal operating state, the address conversion table 11, block state table 12, and address register 13 are placed on the RAM 3 and can be updated at all times. However, when the power is shut off, or when the flash memory 8 is removed (disconnected) from the interface 7, the address conversion table 11, block state table 12, and address register 13 are saved in advance into a physical block “0” of the flash memory 8. When the flash memory 8 is connected to the interface 7, the contents of the tables and register are read from the physical block “0” of the flash memory 8 and written into the RAM 3.

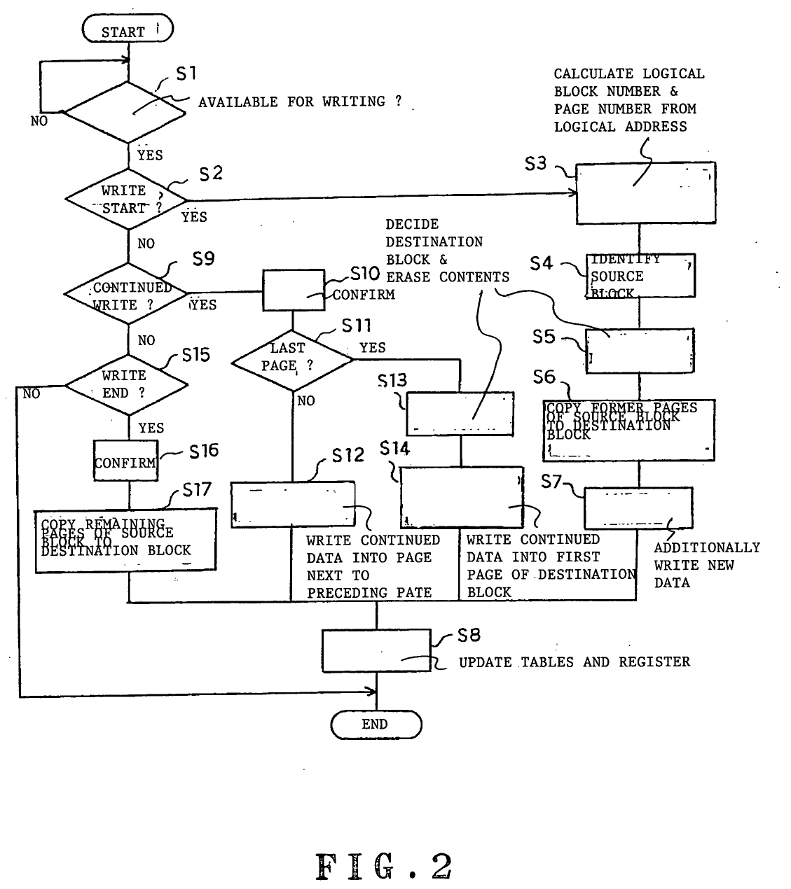

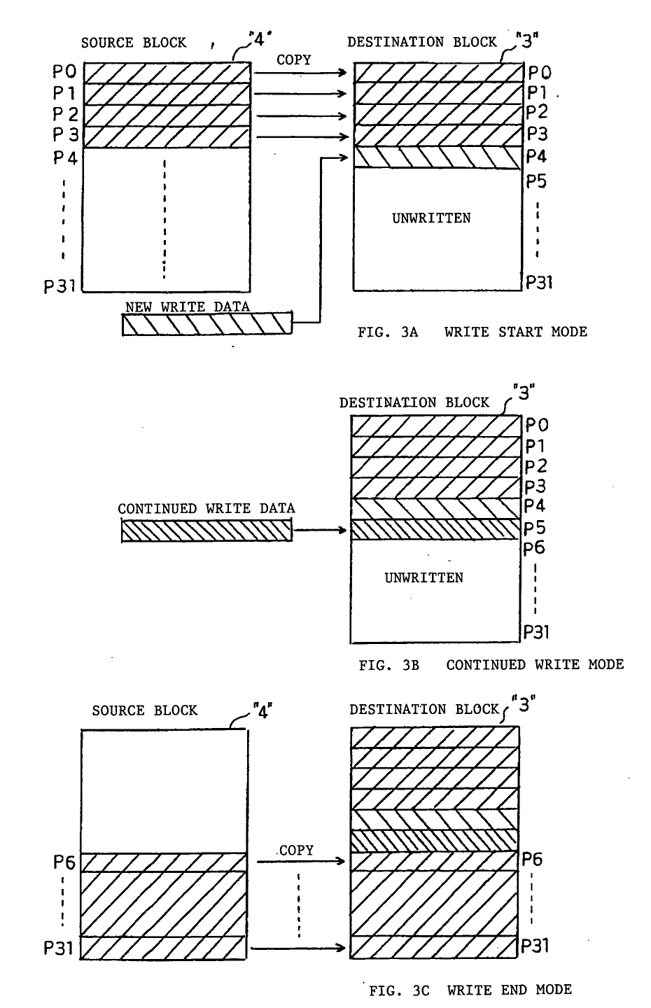

Referring now to FIG. 2, FIG. 3A, FIG. 3B and FIG. 3C, a flash memory writing method (a method of writing data into the flash memory in FIG. 1) will be described. In an example given herein, a write start to a logical address “100” and a continued write to a logical address “101” are instructed from the processor 1. The write start instruction is made for writing new data in the flash memory 8, and the continued write instruction is made when additional (or another) new data should be written in the flash memory 8.

(1) Start of Writing

If an instruction of starting the writing to the logical address “100” is made to the flash memory 8 from the processor 1, it is determined at step S1 in FIG. 2 whether or not the flash memory 8 is available for writing. Whether available for writing or not can be determined by the state of a signal line extending from the flash memory 8. Waiting for the flash memory 8 to become available for writing, the flow proceeds to step S2.

At step S2, it is determined whether or not the instruction is a write start, and the flow proceeds to step S3 if it is a write start, and otherwise proceeds to step S9.

At step S3, a logical block number and a page number are calculated from the given logical address “100.” Specifically, the logical address “100” is divided by 32, and the resulting quotient “3” indicates the logical block address, while the remainder “4” indicates the logical page number. Stated another way, lower five bits of a logical address represented in binary indicate a logical page number, and the remaining upper bits indicate a logical block number. In this way, a write start mode is entered, as shown in FIG. 3A.

At step S4, referring to the address conversion table 11, a source block is identified. In this example, a physical block 4 corresponds to a logical block “3” in the address conversion table 11. Thus, the physical block “4” is determined to be a source block.

At step S5, a destination block is determined with reference to the block state table 12. Since the state of the physical block “3” in the block state table 12 is zero, i.e., no effective data has been written therein, this physical block “3” is used as a destination block. The contents of all pages in the physical block “3” are erased for write processing.

At step S6, preceding pages of the source block are copied to the destination block. Specifically, pages P0-P3 of the physical block “4,” which is the source block, are copied to the corresponding pages P0-P3, respectively, of the physical block “3” which is the destination block.

At step S7, new data is written into the destination block. Specifically, new write data given from the processor 1 is written into the page P4 specified by the logical page number of the physical block “3” (i.e., the destination block). In this way, the pages P0-P4 of the destination block have been written, while pages P5-P31 are maintained in an unwritten state. After step S7, the flow proceeds to step S8.

At step S8, the tables and register are updated. Since the contents of the physical block “4”, which so far corresponds to the logical block “3,” have been copied to the physical block “3,” the physical block “3” is now made to correspond to the logical block “3” in the address conversion table 11. In the block state table 12, the state of effective data being written is set up in the physical block “3,” and the state of no effective data being written is set up in the physical-block “4.” The address register 13 preserves the logical address, as well as the source block and destination block numbers, used in the just-finished writing processing. With the processing at step S8, the write start processing is completed.

(2) Continued Writing

If an instruction of continuous writing to the logical address “101” is made to the flash memory 8, it is determined at step Si whether or not the flash memory 8 is available for writing, and then it is determined at steps S2 and S9 whether or not the instruction is a continued write. The flow proceeds to step S10 if the instruction is a continued write, and otherwise to step S15.

At step S10, it is confirmed whether or not the given logical address “101” is the address next to the preceding logical address preserved in the address register 13. Upon confirming, a continued write mode is entered, as shown in FIG. 3B.

At step S11, it is determined whether or not the page number of the preceding logical address preserved in the address register 13 is the final page (i.e., P31). This determination is made because if a page which was written the preceding time is the last page of the destination block, no available page exists in the destination block so that a new destination block must be found out. The flow proceeds to step S12 if not the last page, while the flow proceeds to step S13 if the last page.

At step S12, additional new data given from the processor 1 is written into the page next to the page which was written the last time. In this example, the new additional data (i.e., continued data) is written into page P5. Thus, the pages P0-P5 of the destination block have been written, while the pages P6-P31 are maintained in an unwritten state. After step S7, the flow proceeds to step S8.

On the other hand, if the last page is occupied by the new data in the previous writing operation (i.e., YES at step S11), the flow proceeds to step S13. At step S13, another destination block is determined, and the contents stored in this block are erased in a manner similar to step S5. Subsequently, at step S14, the continued data given from the processor 1 is written into the top page (page P0) of the destination block. After step S14, the flow proceeds to step S8.

At step S8, the tables and register are updated, and the continued write processing is completed. (3) End of Writing

If an instruction of ending the write into the logical address “102” is made to the flash memory 8, it is determined at step S1 whether or not the flash memory 8 is available for writing, and it is determined at steps S2, S9 and S15 whether or not the instruction is a write end. The flow proceeds to step S16 if it is the write end, and otherwise, the writing processing is immediately terminated.

At step S16, it is confirmed whether the given logical address “102” is the address next to the preceding logical address preserved in the address register 13. With this confirmation, a write end mode is entered, as shown in FIG. 3C.

At step S17, pages P6-P31 of the physical block “4,” which is the source block, are copied to unwritten pages P6-P31, respectively, of the physical block “3” which is the destination block. After step S17, the flow proceeds to step S8, where the tables and register are updated, followed by the termination of the write end processing.

The write end processing is executed in combination with the write start processing and continued write processing when only a particular page within a logical block is rewritten. The write end processing need not be used when new data is sequentially written as is the case of sequentially preserving image data in a digital camera.

As described above, when the flash memory writing method according to this embodiment writes new data, the writing method copies only preceding old pages of a source block to a destination block, writes the new data in the next page, and terminates the write processing. Therefore, when continued data is written subsequent to the new data, the continued data can be sequentially written into an unwritten page next to that page. A writing time can be significantly reduced because all pages in the source block other than the rewritten pages need not be copied to the destination block.

Also, since the frequency of whole block erasure is reduced, the lifetime of the flash memory becomes longer.

It should be noted that the present invention is not limited to the foregoing embodiment, but can be modified in a variety of manners. Exemplary modifications include, for example, as follows:

(a) A flash memory may be attached to other than a digital camera. In other words, the system is not limited to the digital camera.

(b) The total storage capacity of the flash memory, and the sizes of the block and page are not limited to those described above.

(c) The confirmation steps S10 and S16 may be omitted in the continued writing processing and write end processing.

(d) Although the address register 13 preserves a logical address which was used in the preceding writing processing, as well as the numbers of physical blocks in the source and destination, the address register 13 may preserve information in preparation for the next writing processing.

This application is based on a Japanese Patent Application No. 2004-176939 filed on Jun. 15, 2004, and the entire disclosure thereof is incorporated herein by reference.

1. A method for writing data into a flash memory, wherein the flash memory has a plurality of physical blocks, each said physical block has a predetermined number of continuous physical pages, each said physical page has a certain storage area, data writing in the flash memory is possible in units of said physical page, and data erasing in the flash memory is possible in units of said physical block, and a processor coupled to the flash memory is adapted to specify a logical address and issue one of a write start instruction, a continued write instruction and a write end instruction, said method comprising:
providing an address conversion table indicating a relationship between a plurality of logical block numbers and the plurality of physical blocks of said flash memory, respectively;
providing a block state table indicating whether or not effective data is written for each of said plurality of physical blocks;
providing an address register for preserving a formerly used logical address used in a preceding data writing operation, a formerly used physical block number of a source used in the preceding data writing operation and a formerly used physical block number of a destination used in the preceding data writing operation;
wherein when said processor issues the write start instruction, the method comprises:
determining a logical block number from the specified logical address and determining, from the specified logical address, a page number within a block having the determined logical block number;
referring to said address conversion table to specify a source physical block corresponding to the determined logical block number;
referring to said block state table to determine a destination physical block in which no effective data is written;
erasing contents stored in the determined destination physical block;
copying from a first physical page to a physical page preceding to the determined page number in the specified source physical block to the determined destination physical block; and
writing the data into a physical page having the determined page number in the determined destination physical block;
when said processor issues the continued write instruction, the method comprises writing additional data specified by said processor into a page next to the physical page of the determined destination physical block into which the data has been written by said write start instruction; and
when said processor issues the write end instruction, the method comprises copying all remaining pages in the specified source physical block to all remaining pages in the determined destination physical block respectively.

2. The method according to claim 1, wherein the flash memory is an NAND type flash memory.

3. The method according to claim 1, wherein the flash memory is a SmartMedia (trademark).

4. The method according to claim 1, wherein the flash memory is an external storage device to a digital camera, and the processor is a part of the digital camera.

5. A method for writing new data and additional data into a flash memory upon a new data writing instruction and an additional data writing instruction from a processor, the flash memory being coupled to the processor, the flash memory having a plurality of physical blocks, each said physical block having a predetermined number of continuous physical pages, said method comprising:
determining a logical block number from a logical address supplied from the processor;
determining, from the logical address, a page number within a block having the determined logical block number;
specifying a source physical block corresponding to the determined logical block number;
finding a destination physical block in which no effective data is written;
erasing contents stored in the determined destination physical block;
copying from a first physical page to a physical page preceding to the determined page number in the specified source physical block to the determined destination physical block;
writing the new data supplied from the processor into a physical page having the determined page number in the determined destination physical block; and
writing the additional data supplied from said processor into a page next to the physical page of the determined destination physical block.

6. The method according to claim 5 further comprising copying all remaining pages in the specified source physical block to all remaining pages in the determined destination physical block respectively.

7. The method according to claim 5, wherein the flash memory is an NAND type flash memory.

8. The method according to claim 5, wherein the flash memory is a SmartMedia (trademark).

9. The method according to claim 5, wherein the flash memory is an external storage device to a digital camera, and the processor is a part of the digital camera.

10. An apparatus comprising:
a processor;
a flash memory coupled to the processor to write new data and additional data in the flash memory upon a new data writing instruction and an additional data writing instruction from the processor, the flash memory having a plurality of physical blocks, each said physical block having a predetermined number of continuous physical pages;
means for determining a logical block number from a logical address supplied from the processor;
means for determining, from the logical address, a page number within a block having the determined logical block number;
means for specifying a source physical block corresponding to the determined logical block number;
means for finding a destination physical block in which no effective data is written;
means for erasing contents stored in the determined destination physical block;
means for copying from a first physical page to a physical page preceding to the determined page number in the specified source physical block to the determined destination physical block; and
means for writing the new data supplied from the processor into a physical page having the determined page number in the determined destination physical block; and
means for writing the additional data supplied from said processor into a page next to the physical page of the determined destination physical block.

11. The apparatus according to claim 10 further comprising means for copying all remaining pages in the specified source physical block to all remaining pages in the determined destination physical block respectively.

12. The apparatus according to claim 10 further comprising:
an address conversion table indicating a relationship between the plurality of logical block numbers and the plurality of physical blocks of said flash memory, respectively; and
a block state table indicating whether or not effective data is written for each of said plurality of physical blocks.

13. The apparatus according to claim 10 further comprising an address register for preserving a formerly used logical address used in a preceding data writing operation, a formerly used physical block number of a source used in the preceding data writing operation and a formerly used physical block number of a destination used in the preceding data writing operation.

14. The apparatus according to claim 10, wherein the flash memory is an NAND type flash memory.

15. The apparatus according to claim 10, wherein the flash memory is a SmartMedia (trademark).

16. The apparatus according to claim 10, wherein the flash memory is an external storage device to a digital camera, and the processor is a part of the digital camera.
